(19) United States
(12) Patent Application Publication
(10) Pub. No.: US 2005/0202292 A1
(43) Pub. Date: Sep. 15, 2005

(54) Portable fuel cell power supply

(76) Inventors: William R. Richards, Springfield, VA (US); Alan L. Volker, Springfield, VA (US); Jaspal Brar, Burke, VA (US)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/075,892

(22) Filed: Mar. 10, 2005

Related U.S. Application Data
(60) Provisional application No. 60/551,337, filed on Mar. 10, 2004.
(60) Provisional application No. 60/551,338, filed on Mar. 10, 2004.

(51) Int. Cl. H01M 8/04

(52) U.S. Cl. 429/22; 429/34; 429/23

(57) ABSTRACT

A portable proton exchange membrane fuel cell power supply system has a high pressure hydrogen gas supply that is provided from hydrogen storage cylinders that are enclosed in a case that has through holes for ventilation to prevent hydrogen gas concentrations from reaching explosive levels. Enclosed in a second case are a fuel cell stack, control unit, variable speed air compressor and power inverter. The cases incorporate lightweight, high-strength non-metallic materials and foam insulation to render the contents shock resistant. In operation a hydrogen gas connection line is made to extend between the hydrogen cylinders and the fuel cell that is connected through quick disconnect valves. The compressor is also connected to the fuel cell through a quick disconnect valve. Start up of the fuel cell is accomplished with a battery supplying power to the compressor while hydrogen gas is supplied at the same time.

### FIELD OF THE INVENTION

The invention relates to a portable power supply that has a fuel cell for generating power from a source of hydrogen gas.

### BACKGROUND OF THE INVENTION

A need exists for a portable power generation system or power supply that is capable of providing continuous or intermittent power over a period of time. Such a power supply must have its own source of hydrogen gas, in the case of a proton exchange membrane fuel cell (PEMFC).

Prior art solutions have typically relied on the use of metal hydride containment systems for providing a source of relatively low pressure (i.e., typically 200 to 300 psig) storage of hydrogen gas. A metal hydride storage cylinder provides the capability to achieve up to a 2.5 to 3× improvement in the amount of hydrogen gas that may be contained within a defined containment volume versus that of an equivalent high pressure (2600 to 3000 psig) gas storage system.

Although volumetrically efficient, a metal hydride storage cylinder as a hydrogen supply is disadvantageous because of its weight. Additional liabilities to the consideration of metal hydride storage systems include recharging times of from 2.5 to 3.0 hours, special setups for preheat/heat rejection during recharging, and consideration of the hysteresis effect whereby the ability to effect a full charge degrades over time. A typical metal hydride storage cylinder, with an integral isolation valve and reducing/regulating assembly, capable of holding 30 ft.³ of hydrogen gas at charge pressures of 200 to 300 psig, would weigh approximately 20 lbs., and have an envelope of approximately 4″ diameter by 20″ long. This amount of hydrogen gas provides less than approximately 1400 watt-hours of stored energy for a PEMFC stack, or approximately 14 hours of operation time at 100 watts output power. To achieve 8000 watt-hours of stored energy, therefore, would require the use of up to six of these assemblies, and yield a resultant weight of over 120 lbs.

Reformer-based technologies for hydrogen gas generation, using liquid hydrocarbon fuels are not known to be readily available. Capability to provide a lightweight/compact fuel processor assembly capable of providing approximately 2.0 SCFH flow volumes of hydrogen gas at room temperatures for on-demand (i.e., instant startup) would be necessary for a portable power supply.

The consideration of using of high pressure hydrogen gas storage systems has previously been limited to the use of rechargeable “lecture bottle” size pressure vessels, typically providing less than one (1) pint capacity, or capability to store approximately 2.5 ft³ of hydrogen gas at 2200 psig. This amount of hydrogen gas provides less than 100 watt-hours of useable stored energy for use by the PEMFC stack, or less than one hour operation for a stack generating 100 watts of output power.

It would be desirable to provide a fuel cell based portable power system that provides a long period of time, typically 5 to 20 hours of operation or more in order to be considered an effective alternative to the advanced high energy density rechargeable batteries that are available. One attempt to achieve this increased capacity would be to use multiple bottles connected via some form of distribution header subassembly to allow parallel connectivity of each of the respective bottles. This has many disadvantages, however, such as: increased number of potential gas leakage points, increased the complexity of the storage system. Further, transport of such a system becomes difficult with respect to meeting handling/transport environment standards regarding safety and reliability. Additionally, typical high pressure hydrogen supply systems require a storage cylinder isolation valve with each cylinder and a pressure reducing regulator valve to lower the storage systems supply pressure to values of 3 to 25 psig. Accordingly, a satisfactory portable fuel cell power supply is not available in the prior art.

For example, the ability to safely handle and/or transport a fully-charged hydrogen gas storage system, or a storage system with a residual or partial charge, is not a trivial problem. Capability to assure leak-tight integrity (i.e., Class 6 “bubble-tight” conditions) under the rigors of handling, transport shock and vibration effects, and environmental extremes is an important practical consideration. Most significantly, concentration limits of above approximately 4% by volume for hydrogen gas in air in an enclosed space create a lower threshold for ignition combustion risk. Therefore, even a slow leak, considered virtually unmeasurable at rates of 0.125 cc/hour, could still raise the concentration threshold to this 4% limit within a captive volume such as a small shipping container, or storage space.

### SUMMARY OF THE INVENTION

It is an object of the present invention to provide a portable power supply that has a fuel cell for generating power from a source of hydrogen gas. Portability is defined for the purposes of this application as a unit having a fuel cell and a self-contained source of hydrogen that does not exceed approximately 50 pounds of weight, and then is therefore able to be carried by a person without the requirement for a device to assist in carrying the unit.

It is an object of the invention to provide a portable power supply that has a fuel cell for generating power from a source of hydrogen gas that provides more than 14 hours of operation at 100 watts output power or 1400 watt-hours.

It is a further object of the invention to provide hydrogen as the source of fuel for the fuel cell to be contained in a cylinder storage system and encased in a container that provides safe and reliable handling of the storage cylinders meeting or exceeding transportation and environmental standards.

It is an object of the present invention to provide a portable power supply having a fuel cell that generates power from hydrogen provided in storage cylinders that includes a power converter and a control unit. The portable power supply further includes connection devices for connecting the storage cylinders to the fuel cell, a variable delivery air compressor for providing air to the fuel cell and a one or two part container system for containing the components of the portable power supply system. Once the hydrogen gas is connected to the fuel cell, the compressor provides air to the fuel cell, the power from the fuel cell is provided for direct output or output through a power converter continuously until the supply of stored hydrogen gas is exhausted.

### BRIEF DESCRIPTION OF THE DRAWINGS

FIG. 1 comprises FIGS. 1A and 1B and together show the portable fuel cell power supply of the invention;

FIG. 2 is a perspective view of a fuel cell stack used in the portable fuel cell power supply of the invention;

FIG. 3 is a partial section view of the case shown in FIG. 1A combined with a schematic diagram of the hydrogen storage cylinders and connections;

FIG. 4 is a schematic diagram of the electrical connections among the components of the portable fuel cell power supply system of the invention; and

FIG. 5 is a block diagram of the control unit of the portable fuel cell power supply system of the invention.

### DESCRIPTION OF THE PREFERRED EMBODIMENT

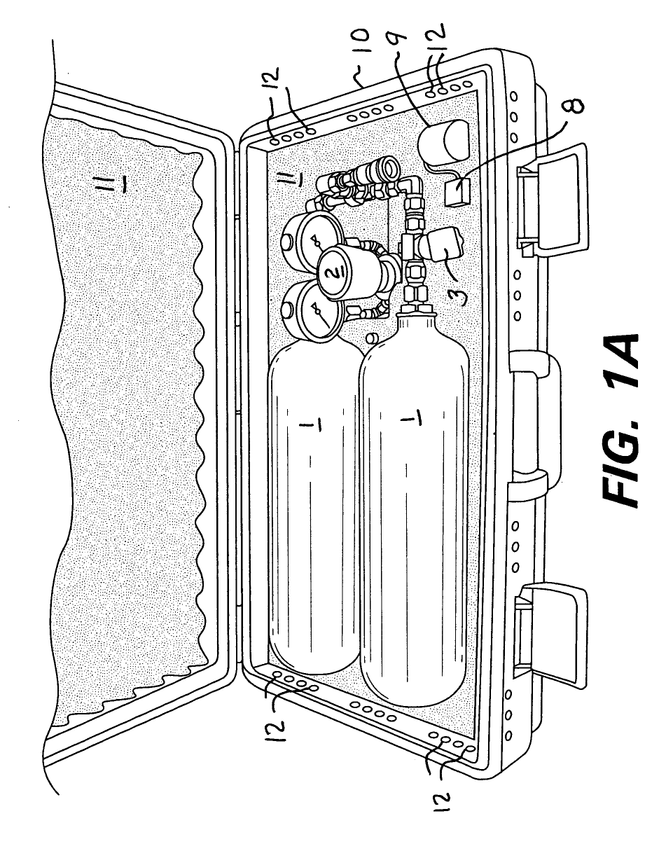

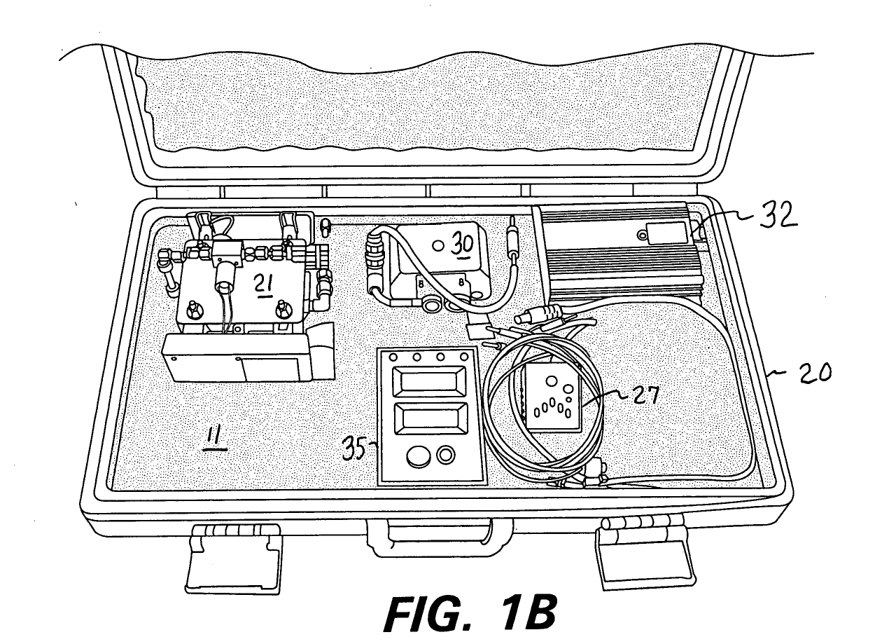

FIG. 1 shows the preferred embodiment of a power supply system of the invention. FIG. 1 is comprised of FIG. 1A and FIG. 1B. FIG. 1A shows a case 10 containing 2 storage cylinders 1 that are essentially identical providing about a 2000 watt-hour gas storage system for a 330 watt fuel cell stack. FIG. 1B shows a case 20 containing a nominal 12 VDC, 330 watt, 16 cell PEMFC fuel cell stack or assembly 21, low noise (less than 58 dBA), variable delivery air compressor 30, power inverter 32 for providing 115 VAC output power and control unit 35 that enables the operator to start and stop operation of the power supply, and also to monitor performance of the fuel cell and ensure safe operating conditions. Each of the cases 10, 20 contains an open cell foam 11 and each is preferably an ABS suitcase that has approximate dimensions, according to a preferred embodiment, of 24″ (long)×14.5″ (wide)×7″ (deep), with each weighing less than 7.5 lbs.

The total weight of the complete power supply system is preferably under 45 lbs., with Case 10 weighing 20 lbs., and containing two 3000 psig hydrogen gas storage and supply cylinders 1. Preferably, the storage cylinders are compatible with DOT-10915-3000 and are commercially available carbon composite, metal-lined, cylinders. It should be noted that the fuel cell stack 21, the air compressor 30 and the inverter 32 may be increased in size to provide up to a nominal 1-kW output power capacity, yet be accommodated within the same packaging envelope as the smaller sized unit, and weigh under 50 lbs.

Both cases 10, 20 are designed to accommodate the rigors of handling and/or ground transport and preferably double as their own “shipping containers”—providing isolation/protection from vibration and/or shock effects, preferably up to 25 Gs.

In case 10, a hydrogen sensor 8, which is preferably a Neodym KNOWZ Gas Detector, set at 20% of the lower threshold limit of 40,000 ppm Hydrogen, is used to trigger a fire retardant canister 9, which is preferably a squib-actuated aerosol generator similar to the Aero-K. Canister 9 produces an exceptionally effective, ultra-fine potassium based aerosol. A minimum of approximately 2 gms of aerosol are provided in the canister (packaged in a canister about ¼th the size of a typical 12 oz. coke can) to provide up to 70 cubic feet of coverage. The canister is preferably also triggered by a temperature sensor (not shown) that triggers upon sensing a temperature condition of 240 Deg. F. or higher.

Case 10 preferably includes additional features to assure that undetectable leakage rate effects (i.e., approximately 0.125 cc/hour) do not raise the concentration of the hydrogen gas in the case above 0.8% by volume to air, which provides an ample margin of safety. This capability is provided by a multiplicity of ventilation holes 12 arrayed about the free-space volume between the upper and lower halves of case 10. These holes facilitate the unimpeded (free) circulation of air within the case envelope, and permit air exchange to occur at rates at or below 0.3 FPM, or approximately 0.3 SCFH. This is the equivalent of making a complete change in the volume of air contained within the case approximately once every four hours. Increasing the number of holes by a factor of two or more would allow a proportional increase in the overall design margin of safety.

Case 10 preferably provides a fully-integrated hydrogen supply system with all necessary connection interfaces necessary to facilitate the ease of operator setup and operation of the power generation unit contained in Case 20. “Make-break” connectivity is provided by a 5 to 20 foot long flexible hosing assembly 28 having standard “quick-connect” double-ended shutoff features to isolate both the supply source and the PEMFC stack 21 the instant that disconnect occurs. The unit is designed to avoid operator handling of the hydrogen gas cylinders 1, or to need to remove the cylinders and connection equipment from case 10. “Make-break” connectivity is similarly provided to effect the safe and reliable recharging of the hydrogen storage cylinders, and allows for recharging without the need to handle or remove the cylinder assembly from its protective case.

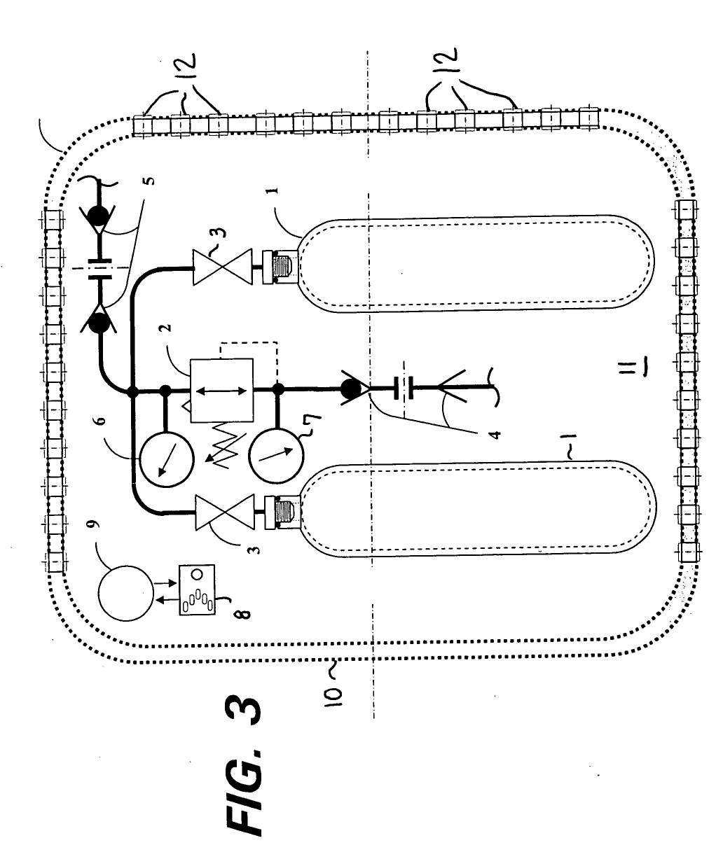

The connections among the storage cylinders 1, the regulator 2, and the lines connecting them to the fuel cell are shown schematically in FIG. 3. As shown, the storage cylinders are connected to a regulator 2 and a quick disconnect valve 5 that is on the high pressure or unregulated side of the regulator. The pressure can be monitored with gauge 6 on the high pressure side and with a gauge 7 on the regulated side. A quick disconnect valve 4 is provided for connection to the fuel cell stack 21.

The preferred manner for recharging the cylinder assembly from a high pressure hydrogen supply source is as follows: (Assuming that the cylinders are fully discharged)
1. Connect a Vacuum Pump to the connection 5 and open up the manual isolation valves 3 to draw a vacuum to greater than 25″ mercury gauge, then close the valves. This assures that very little air remains in the cylinders. Note: If the high pressure gauge shows any residual pressure, this step can be eliminated, and the recharging process moved onto the next step.
2. Connect a high pressure hydrogen re-charging system (not shown) to the connection 5. This system preferably requires the use of an inline multi-turn metering valve immediately downstream from the main hydrogen isolation valve. Any existing pressure reducing/regulator assembly may be adapted to this purpose by removing the existing high pressure gauge from its port, and installing an inline tee to incorporate both the pressure gauge and the multi-turn metering valve. A high pressure flexible line with an inline quick disconnect “make-break” fitting is then employed to make the connection to the connection 5.
3. Open the hydrogen supply cylinder isolation valve 3 for one cylinder and slowly crack the inline metering valve. Observe the pressure gauge, and close the metering valve once the pressure reaches the desired pre-charging value of approximately 3000 psig. Repeat for the second cylinder. Recharging time is typically less than one minute before the supply cylinder isolation valve may be closed and the charging line disconnected from the unit.
4. The manual isolation valves 3 to the unit are closed, and Case 10 is then ready for use with the PEMFC fuel cell assembly located in Case 20.

Alternatively, the cylinder assembly could be recharged via means of a separate, stand-alone, electrolysis unit (i.e., a “base station”, or similar, that needs not be portable) sized to provide the desired volume of hydrogen gas in a period of approximately three to four hours, or, requires that hydrogen generation be accomplished at a rate of approximately 12.5 to 15 SCFH per 2000 watt-hour hydrogen storage system. An inline compressor assembly is utilized to boost the pressure from ambient sea level pressure up to the desired pre-charging pressures of approximately 3000 psig. The electrolysis unit could be solar powered to provide a system of power supply that merely requires water and sunlight to provide an independent supply of power.

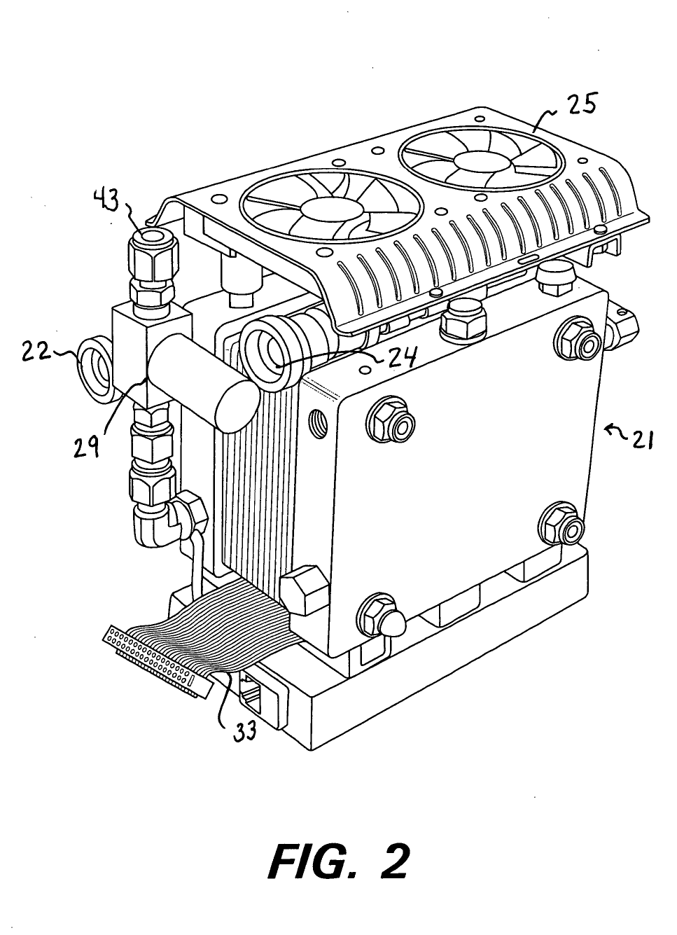

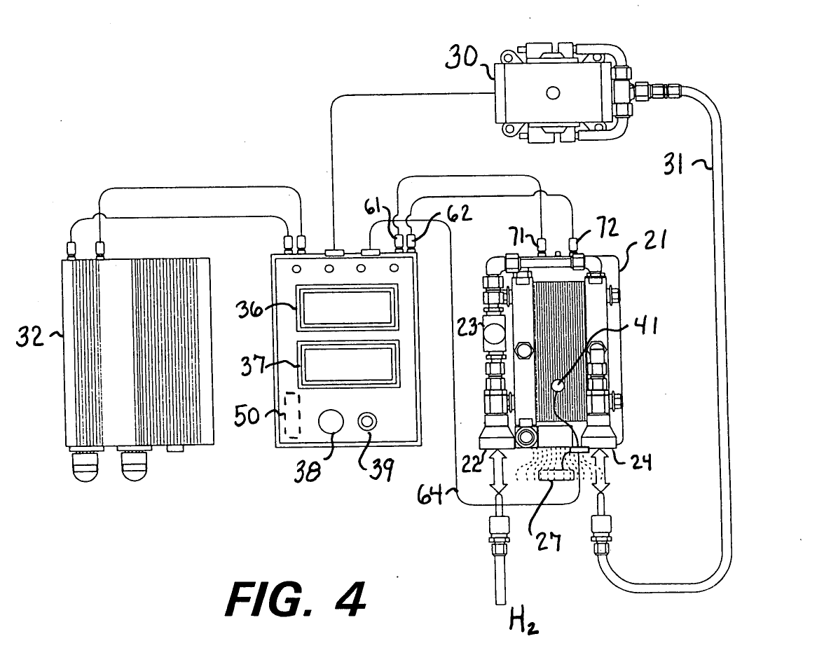

Case 20 provides features to assure for the safe operation of the fuel cell stack under all operational conditions, by integration of failsafe hydrogen isolation valve 23 (FIG. 4) at the hydrogen inlet 22 (FIG. 2) of the fuel cell stack. A hydrogen sensor 27 in case 20 used during operation of the fuel cell (FIG. 4) senses hydrogen concentration levels, and a temperature sensor 41 detects temperature of the fuel cell stack (FIG. 4). If the level of detected hydrogen exceeds 1% by volume, or if the sensing of an over-temperature condition on the stack itself occurs, hydrogen supply to the stack will be completely isolated by isolation valve 23 to prevent any significant release of hydrogen directly into the environment. Additional safety features include overload sensing for either 12 VDC, 24 VDC or 115 VAC power generation in the inverter.

The power supply of the invention is capable of storing hydrogen gas at pressures of 3000 psig, with associated design pressure rating of 5000 psig. The overall system is lightweight/compact and capable of being rated as Class 6 (bubble tight). Safety considerations, with respect to assuring that spontaneous combustion risk is minimized, is provided by the air circulation holes 12 in the case 10 and the fire suppression canister 9 that is activated by either a hydrogen gas sensor 8 or an over temperature condition sensor (not shown). Further, during operation of the fuel cell, failsafe shutdown occurs in the event of hydrogen concentration thresholds reaching approximately 20% of the allowable threshold limits or exceeding over-temperature limits on the fuel cell stack itself as sensed by hydrogen sensor 27 or temperature sensor 41.

The power supply is made up of two lightweight subassemblies (cases 10 and 20) and weighs less than 50 lbs. when fully charged and is capable of providing greater than 2000 watt-hours of operation for the fuel cell stack with an output power capability up to 1-kW. In addition, the portable power supply system is based upon PEMFC technology, in the preferred embodiment, and is therefore price competitive with existing high energy density battery systems. Additional hydrogen storage capacity can be provided by increasing the number of configurations of dual hydrogen cylinder sets as provide in case 10, to increase the capacity of the portable power system in increments of 2000 watt-hours up to any desired capacity, and limited only by the number of additional cases. Alternatively, three hydrogen cylinders can be provided in one case, or a single larger cylinder, while still maintaining a reasonable total weight, within the teachings of the present invention.

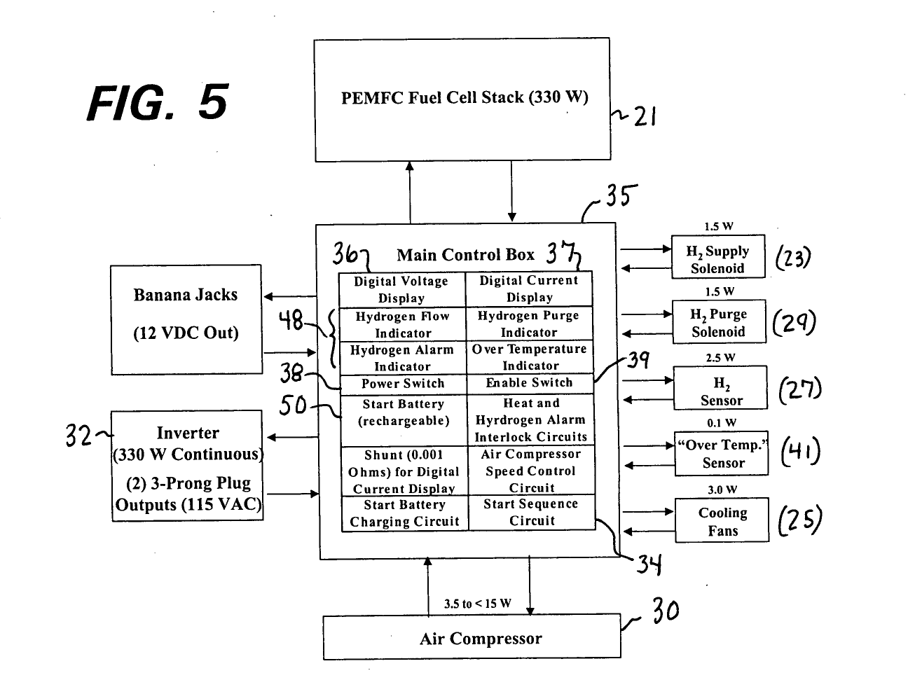

Referring to FIG. 5, the control unit 35 manages several aspects of the fuel cell operation and start up. The control unit manages efficient power consumption of the air compressor, monitors safety considerations, ensures purging of the fuel cell before start up and monitors performance of the stack through display of voltage and current displays.

The PEMFC stack operates from oxygen in the air that is received through inlet 24 (FIG. 2) from air compressor 30 through hose 31. Traditionally an air compressor is designed to provide a fixed flow rate for the PEMFC operating at its peak load. When the stack is operating at a reduced load, however, it does not need the same high airflow rate. This problem is solved by the design of an active feedback control system for modulating the airflow through the PEMFC. The circuit in the feedback control system efficiently adjusts the airflow rate so that it is inversely proportional to the electrical load applied to the PEMFC. The control is achieved by using the relation that the PEMFC stack output voltage decreasing proportionally to the PEMFC stack load increase in Amperes (A).

Using this relation, control of the flow rate of the air through the compressor can be achieved, for example, by using a pulse width modulated fixed frequency oscillator in which the pulse width increases inversely with the PEMFC stack output voltage to change the speed of the air compressor, and therefore the air flow volume being supplied to the stack.

The inverter 32 is used in the portable power supply to deliver 115 or 230 VAC output power. Conventional inverters for 12 Volts Direct Current (VDC) to 115 or 230 VAC inverters that are commercially available will operate in the fuel cell power supply of the invention so long as they operate over an extended input range.

If there is a hydrogen gas leak and or if the stack 21 overheats there is the danger of a fire and/or explosion. To prevent this, the control system incorporates interlocked sensors for hydrogen gas leaks 27 and heat detection 41 that are triggered when the levels rise above a pre-set level. Once triggered, the system stops the flow of hydrogen gas through valve 23 and activates audio and visual alarm signals 48, such as horns and flashing LED's, for example. The system is designed so that a self-test of the alarm circuits occurs when the PEMFC stack is first powered up. If the problem that tripped the alarm goes away, the alarm has to be manually reset before the stack will operate again. As an additional safety control mechanism a thermal trip switch is connected in series with the PEMFC stack which trips if a predetermined current level is exceeded.

When a PEMFC stack is first powered up it needs to be purged so that any oxygen that is in the hydrogen (or anode side of the fuel cell stack) is removed. The control system achieves this by activating a normally closed solenoid valve 23 that is attached to the hydrogen vent side of the PEMFC stack, which allows air into the vent 43.

If is difficult to optimize a PEMFC stack by only monitoring its output VDC and Amperes. Monitoring each of the individual cells that make up the stack helps optimize the design and performance of the stack. This is achieved by connecting an analog to digital (A/D) converter (like the Dataq Instruments DI700) to electrodes attached to each of the cells in the stack and to humidity and temperature sensors. The A/D is then connected to a computer through connector 33 running A/D control software (Like Dataq Instruments Windaq and Windaq-XL). A software program is written utilizing Microsoft Excel to display this data in real time. A preferred embodiment of this software uses running average tables to achieve more accurate data and to use this data to make automatic adjustments to the PEMFC stack that might include: hydrogen and air pressure and flow rates, cooling systems, humidification of the air and hydrogen streams and electrical load adjustment. A wireless connection between the computer and the stack control system and a data logger would be beneficial.

The control system is designed to be energy efficient and simple to control. There are two switches: “on/off” 38 and “start” 39. To start the PEMFC stack the on/off switch 38 is placed in the “on” position. This provides power from a rechargeable start battery 50, which may be part of or separate from control unit 35, to test the interlocking temperature and hydrogen alarm circuits that are coupled to the hydrogen flow solenoid valve 23. If these alarm circuits are not tripped, the “start” switch 39 is held in the start position for a few seconds, starting the start sequence circuit 34. This disconnects the PEMFC stack 21 from the system so that the start battery 50 does not drain into the stack; tests and resets the temperature and hydrogen alarm circuits (27, 41); provides power to the hydrogen purge valve solenoid 23 so the PEMFC stack can be purged while the hydrogen alarm is being reset; opens the normally closed hydrogen purge valve 43 (preferably for a preset time period), allowing for pure hydrogen gas to flow through the fuel cell stack; and provides power from the rechargeable start battery 50 to the air compressor so that air can be pumped through the stack. Under these conditions, the PEMFC stack produces power and when more volts than a set point determined by a rechargeable start battery voltage regulator (part of the control unit 35) is reached, the output of the PEMFC stack takes over powering of the control unit. Further, the start button causes the voltage of the rechargeable start battery 50 to be displayed on the voltmeter display 36 and when the start button is released, the voltmeter display 36 displays the PEMFC stack voltage. The control unit also controls the power supplied to the cooling fans 25 located on top of the fuel cell stack (FIG. 2).

In operation, the fuel cell stack provides power through connection to terminals 71, 72 that are connected to terminals 61, 62 of the control unit. The output is connected to the control unit 35 and then passed on to the inverter 32 through connection between the control unit and the inverter. In this way, power incidental to the operation and monitoring of the operation of the fuel cell is provided to the control unit. Alternatively, the output power terminals of the fuel cell 71, 72 could be directly connected to the inverter 32 and then a power supply necessary for operation of the control unit 35 would be taken from the inverter.

The control unit provides the power to the variable speed air compressor through a power connection cable 63 so that an appropriate amount of power proportional to the load on the fuel cell stack 21 is provided to the compressor. The control unit 35 is also connected to the fuel cell stack 21 by a cable 64 that has signal lines for receiving the output of the sensors 27 and 41, and also has lines for providing the “open” signals to the normally closed hydrogen (inlet) isolation valve 23 and purge valve 29. Since the power for these operations is derived from the power output by the fuel cell, there is a parasitic loss. Overall, approximately 10% parasitic losses are considered acceptable and the control unit has control circuits to preferably maintain the parasitic losses at that level or less.

While preferred embodiments have been set forth with specific details, further embodiments, modifications and variations are contemplated according to the broader aspects of the present invention, all as determined by the spirit and scope of the following claims. For example, all of the fuel cell equipment could be provided in a single case, instead of two cases, as shown. Further, the inverter is included for supplying power at a different voltage as compared with that provided by the fuel cell stack, however the inverter is unnecessary if the voltage output provided by the fuel cell matched that of the load to which the fuel cell is adapted.

1. A portable fuel cell power supply system, comprising:
a fuel cell stack having an air inlet, a hydrogen gas inlet and a pair of electrical load terminals;
a compressor providing atmospheric air connectable to the air inlet of the fuel cell;
a control unit electrically connected to the fuel cell and to the compressor, said control unit having a start battery;
at least one cylinder providing pressurized hydrogen gas that is connectable to the fuel cell; and
one case for containing said at least one storage cylinder and another case for containing said control unit, said fuel cell stack and said compressor.

2. A portable fuel cell power supply, comprising:
a first case containing at least one storage cylinder for hydrogen gas;
a second case containing a fuel cell stack, a compressor, an inverter and a control unit;
wherein said first case and said second case are separate from one another for storage and transportation, and said storage cylinder of hydrogen gas is connected to said fuel cell in operation of said fuel cell, said compressor is connected to said fuel cell and power generation by said fuel cell is started by delivering air through said compressor while delivering hydrogen from said storage cylinder to said fuel cell.

3. A portable fuel cell power supply system, comprising:
a first case storing at least one hydrogen cylinder, said case having shock absorbing material surrounding said hydrogen cylinder and said case being an enclosure having air through holes;
a second case separate from said first case containing a fuel cell having air inlet and hydrogen gas inlet connections respectively, and power output terminals;
an air compressor connectable to said air inlet of said fuel cell stack;
a control unit connected to said power terminals of said fuel cell stack and connected to said air compressor;
an inverter connected to said control unit;
said control unit having a battery and a switch for supplying the battery power to the compressor;
said hydrogen cylinder in said first case being connected to said hydrogen inlet of said fuel cell stack in said second case, and said air supply of said compressor being connected to said air inlet of said fuel cell stack in operation of said power supply wherein operation begins with said battery supplying power to said compressor while hydrogen gas is supplied to said hydrogen inlet.

4. A portable fuel cell power supply system according to claim 3, wherein said hydrogen inlet includes a solenoid operated valve that is controlled by said control unit, wherein said control unit provides hydrogen gas through said solenoid operated valve to begin operation of said fuel cell, and after start up of operation, said air compressor is powered by output of said fuel cell.

5. A portable fuel cell power supply system according to claim 3, further including a hydrogen gas sensor disposed in a vicinity of said hydrogen inlet and connected to said control unit, wherein said control unit closes said solenoid operated valve when said hydrogen sensor detects leakage of hydrogen gas.

6. A portable fuel cell power supply system according to claim 3, wherein said fuel cell stack has a temperature sensor that monitors a temperature of said fuel cell stack that is connected to said control unit, and said control unit operates said solenoid operated valve to close said hydrogen inlet when said a detected temperature exceeds an over-temperature condition.

7. A portable fuel cell power supply system according to claim 3, wherein said first case further includes a hydrogen sensor that is connected to-a canister of fire retardant, wherein detection of 8,000 ppm of hydrogen in said first case triggers release of said fire retardant from said canister.

8. A portable fuel cell power supply system according to claim 3, wherein said first case further includes a thermal sensor connected to a canister of fire retardant wherein detection of a temperature exceeding approximately 240 F. triggers release of said fire retardant from said canister.

9. A portable fuel cell power supply system according to claim 3, wherein said fuel cell stack further includes a purge valve connected to said control unit, said control unit operates said purge valve to purge hydrogen gas from said fuel cell stack before beginning operation of said fuel cell.

10. A portable fuel cell power supply system according to claim 3, further including cooling fans mounted to said fuel cell stack and powered by an output of said fuel cell stack for cooling said fuel cell.

11. A portable fuel cell power supply system according to claim 3, further including said compressor being a variable speed compressor and said control unit controlling an input power to said variable compressor proportional to an output power of said fuel cell.

12. A portable fuel cell power supply system according to claim 3, wherein said control unit further includes display of voltage and current of said fuel cell stack.

13. A portable fuel cell power supply system according to claim 3, wherein said control unit further includes a circuit for recharging said battery from an output power of said fuel cell stack during operation of said fuel cell.
